(19) United States
(12) Patent Application Publication
(10) Pub. No.: US 2023/0382293 A1
(43) Pub. Date: Nov. 30, 2023

(54) METHOD FOR MANAGING IMAGE DATA AND AUTOMOTIVE LIGHTING DEVICE

(71) Applicant: VALEO VISION, Bobigny (FR)

(72) Inventor: Yasser ALMEHIO, Bobigny (FR)

(73) Assignee: VALEO VISION, Bobigny (FR)

(21) Appl. No.: 18/250,573

(22) PCT Filed: Oct. 28, 2021
(86) PCT No.: PCT/EP2021/079941

§ 371 Date: Apr. 26, 2023

(30) Foreign Application Priority Data
Oct. 30, 2020 (FR) FR2011162

(51) Int. Cl. B60Q 1/14; G06T 9/00

(52) U.S. Cl. CPC B60Q 1/143; G06T 9/002

(57) ABSTRACT

An automotive lighting arrangement and a method for manufacturing an automotive lighting arrangement. The method includes training a deep autoencoder to process image data, installing the encoder block in an automotive control unit of an automotive vehicle and installing the decoder block in an automotive lighting module of the automotive vehicle.

### TECHNICAL FIELD

This invention is related to the field of automotive lighting devices, and more particularly, to the management of the electronic data derived from the control of the lighting sources.

### BACKGROUND OF THE INVENTION

Current lighting devices comprises an increasing number of light sources which has to be controlled, to provide adaptive lighting functionalities.

This number of light sources involves a big amount of data, which has to be managed by the control unit. The CAN protocol is often used, in some of their variants (CAN-FD is one of the most used ones) to transfer data between the PCM and the light module. However, some car manufacturers decide to limit the bandwidth of the CAN protocol, and this affects the management operations, which usually requires about 5 Mbps.

Current compression methods are not very efficient for light patterns, and this compromises the bandwidth reduction which is requested by car manufacturers. Higher compression rates always involve a loss of data which may not be acceptable by automotive regulations.

### SUMMARY OF THE INVENTION

A solution for this problem is sought.

The invention provides a solution for these problems by means of a method for manufacturing an automotive lighting arrangement, an automotive lighting arrangement and a method for operating said automotive lighting arrangement.

Unless otherwise defined, all terms (including technical and scientific terms) used herein are to be interpreted as is customary in the art. It will be further understood that terms in common usage should also be interpreted as is customary in the relevant art and not in an idealised or overly formal sense unless expressly so defined herein.

In this text, the term “comprises” and its derivations (such as “comprising”, etc.) should not be understood in an excluding sense, that is, these terms should not be interpreted as excluding the possibility that what is described and defined may include further elements, steps, etc.

In a first inventive aspect, the invention provides a method for manufacturing an automotive lighting arrangement, comprising the steps of
training a deep autoencoder to process image data, the autoencoder comprising at least one encoder block, at least one decoder block and a loss function unit;
install the encoder block in an automotive control unit of an automotive vehicle; and
install the decoder block in an automotive lighting module of the automotive vehicle.

This method is aimed to manage the image data which is exchanged between a control unit and a light module. Instead of using methods of linearizing the values, a convolutional neural network, such as a deep autoencoder, is used to produce compressed data in a encoder block based on image data. The same autoencoder is able to restore the original version of the image data in the decoder block.

The main advantage of this method is the ability to define a flexible data loss, improving the given compression rate. The training may reduce the data loss and the compression rate may be defined for the neural network.

In some particular embodiments, the encoder block comprises a convolution layer, a rectified linear unit layer and a normalization layer.

The presence of several layers contribute to decrease the image size of the training data used in the learning functionality and increase the compression rate.

In some particular embodiments, the method further comprises the step of choosing the ratio between the size of convolution layer of the encoder block and the normalization layer of the encoder block.

This choice is directly related to the compression rate, and will also have influence on the processing speed.

In some particular embodiments, the decoder block comprises an unsampling convolution layer, a rectified linear unit layer and a normalization layer.

The presence of several layers of decoder block contribute to increase the amount of data compressed by the encoder, to find the decompressed image needed to learn the functionality and increase the compression rate.

In a second inventive aspect, the invention provides an automotive lighting arrangement manufactured by a method according to the first inventive aspect, the automotive lighting arrangement comprising
an automotive control unit comprising an encoder block configured to process image data; and
a lighting module comprising a decoder block configured to receive processed image data to restore the original version of the image data, wherein the lighting module is also configured to project a light pattern based on the image data restored by the decoder block;
   wherein the encoder block and the decoder block have undergone a common training process being part of the same deep autoencoder.

This automotive lighting arrangement may be installed in an automotive vehicle for a better operation of the lighting process. Since the encoder block and the decoder block have been trained as parts of the same deep autoencoder, they are perfectly coordinated to obtain an accurate copy of the original image data.

In some particular embodiments, the lighting module comprises solid-state light sources, such as LEDs.

The term “solid state” refers to light emitted by solid-state electroluminescence, which uses semiconductors to convert electricity into light. Compared to incandescent lighting, solid state lighting creates visible light with reduced heat generation and less energy dissipation. The typically small mass of a solid-state electronic lighting device provides for greater resistance to shock and vibration compared to brittle glass tubes/bulbs and long, thin filament wires. They also eliminate filament evaporation, potentially increasing the life span of the illumination device. Some examples of these types of lighting comprise semiconductor light-emitting diodes (LEDs), organic light-emitting diodes (OLED), or polymer light-emitting diodes (PLED) as sources of illumination rather than electrical filaments, plasma or gas.

In a third inventive aspect, the invention provides a method for operating an automotive lighting arrangement according to the previous inventive aspect, comprising the steps of
operating the encoder block to reduce the data size of some image data, producing a processed image data;
transmit the processed image data to the decoder block;
operate the decoder block to process the processed image data to produce a restored image data; and
operate the lighting module to project a light pattern based on the restored image data.

This method allows the automotive arrangement to operate with a lower communication bandwidth than the traditional ones. The processed images data produced as the output of the encoder represents the compressed image. Then, the decoder receives the compressed data as input to restore an image as closer as possible to the original image data.

In some particular embodiments, the method comprises a step of normalizing the image data before operating the encoder block to reduce its data size. Particularly, the step of normalizing the image data comprises converting each value of the image data in a converted value comprised between 0 and 1.

This normalization is used to improve the autoencoder operation, since these normalized values are optimal for its operation.

In some particular embodiments, the method comprising a step of dividing the image data in data subarrays of the same format, before operating the encoder block to reduce its data size.

Each type of lighting pattern (low beam, high beam . . . ) may operate with particular features. If these features are isolated in different subarrays, and treated independently, the compression and operation of the arrangement will be improved.

### BRIEF DESCRIPTION OF DRAWINGS

To complete the description and in order to provide for a better understanding of the invention, a set of drawings is provided. Said drawings form an integral part of the description and illustrate an embodiment of the invention, which should not be interpreted as restricting the scope of the invention, but just as an example of how the invention can be carried out. The drawings comprise the following figures:

FIG. 1 shows a first step of a method for manufacturing an automotive lighting arrangement according to the invention.

FIG. 2 shows an automotive vehicle where these two elements of the lighting arrangement are installed.

FIG. 3 provides a detailed image of the operation of this lighting arrangement.

### DETAILED DESCRIPTION OF THE INVENTION

In these figures, the following reference numbers have been used:
1 Deep autoencoder
2 Encoder block
21 Convolution layer of the encoder block
22 Rectified linear unit layer of the encoder block
23 Normalization layer of the encoder block
3 Decoder block
31 Unsampling convolution layer of the decoder block
32 Rectified linear unit layer of the decoder block
33 Normalization layer of the decoder block
4 Central control unit of the vehicle
5 Lighting device
6 Image pattern
10 Automotive vehicle
61 First portion of image pattern (flat)
62 Second portion of image pattern (kink)
71 First vector
72 Second vector
81 First restored image
82 Second restored image

The example embodiments are described in sufficient detail to enable those of ordinary skill in the art to embody and implement the systems and processes herein described. It is important to understand that embodiments can be provided in many alternate forms and should not be construed as limited to the examples set forth herein.

Accordingly, while embodiment can be modified in various ways and take on various alternative forms, specific embodiments thereof are shown in the drawings and described in detail below as examples. There is no intent to limit to the particular forms disclosed. On the contrary, all modifications, equivalents, and alternatives falling within the scope of the appended claims should be included.

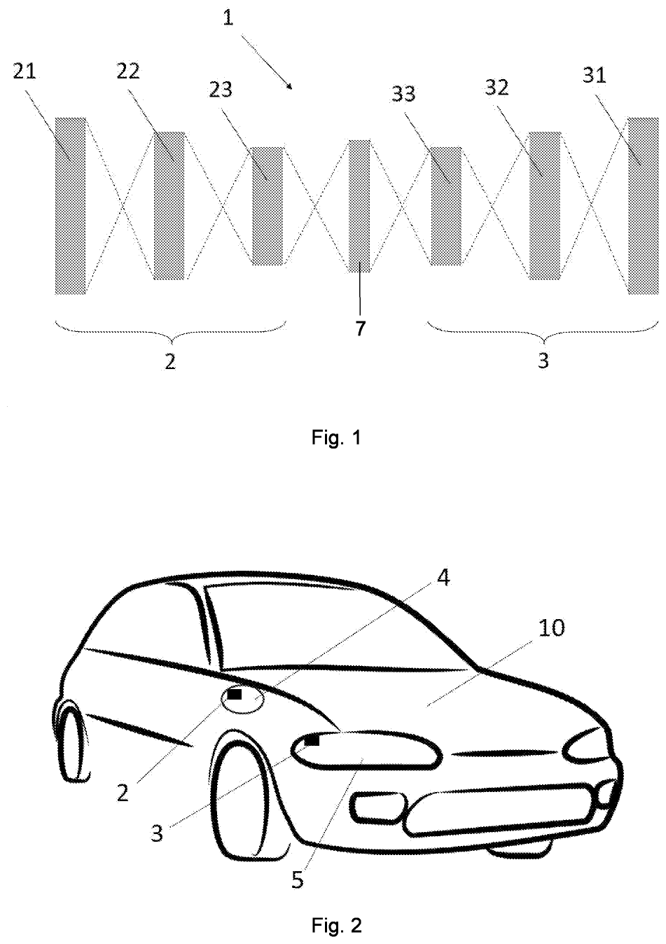

FIG. 1 shows a first step of a method for manufacturing an automotive lighting arrangement according to the invention.

In this first step, a deep autoencoder 1 is trained to process image data. This autoencoder 1 comprises one encoder block 2, one decoder block 3 and a loss function unit 7 to minimize the error produced by the autoencoder 1.

This training may be performed with real light patterns that will be provided by the automotive manufacturer, so that the compression may be optimized and the autoencoder may provide the minimum data loss possible for a given compression rate.

The encoder block 2 comprises a convolution layer 21, a rectified linear unit layer 22 and a normalization layer 23, while the decoder block 3 comprises an unsampling convolution layer 31, a rectified linear unit layer 32 and a normalization layer 33. The presence of several layers contribute to decrease the amount of training data needed to learn the functionality and increase the compression rate.

The compression rate is given by the ratio between the size of the convolution layer 21 and the size of the normalization layer 23 of the encoder block 2, which will provide the size of the data which is transmitted to the decoder block 3. This is relevant, since, once this autoencoder 1 has been trained, the decoder block 3 will be separated from the encoder block 2, and each element will be installed in different parts of an automotive vehicle.

FIG. 2 shows an automotive vehicle 10 where these two elements of the lighting arrangement are installed. This vehicle comprises a central control unit 4 and a lighting device 5. The encoder block 2 is installed in the control unit 4 of the vehicle, which is intended to produce the image data that should be projected by the lighting device 5. The encoder 3 is therefore configured to process these image data and produce a compressed data. The decoder 3 is installed in the lighting device 5, and is configured to receive the compressed data produced by the encoder and decompress it, thus providing the lighting device with the information needed to project the required light pattern.

This lighting device 5 therefore achieves a good quality projection with an improved transmission bandwidth.

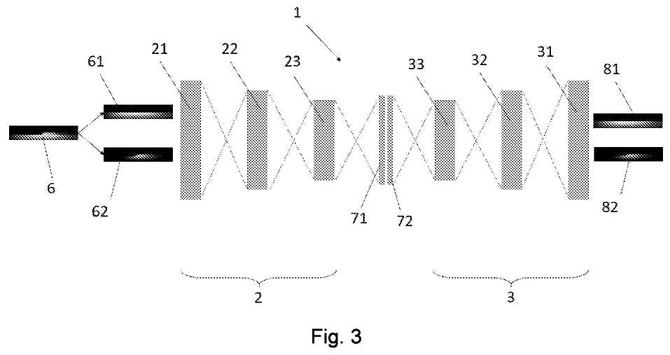

FIG. 3 provides a detailed image of the operation of this lighting arrangement.

Firstly, an image pattern 6 is produced by the control unit of the vehicle. This image pattern is sent to the encoder block, which divides the image in different portions, according to the nature of the same.

In this case, since the image is a low beam pattern, a first portion 61 comprises the flat and a second portion 62 comprises the kink. These two images are normalized so that the luminous intensity of each pixel is scaled to the range between 0 and 1. Then, the normalized data undergo the encoding processing, where two vectors 71, 72 are produced.

These two vectors 71, 72, which have a size which is substantially lower than the original pattern 6, are transmitted to the lighting device.

There, the decoder receives the vectors 71, 72 and processes them, producing two restored images 81, 82, one for the flat and another one for the kink. They are joint and sent to the lighting module so that they are finally projected.

1. A method for manufacturing an automotive lighting arrangement, comprising:
training a deep autoencoder to process image data, the autoencoder including at least one encoder block, at least one decoder block and a loss function unit;
install the encoder block in an automotive control unit of an automotive vehicle; and
install the decoder block in an automotive lighting module of the automotive vehicle.

2. The method according to claim 1, wherein the encoder block comprises includes a convolution layer, a rectified linear unit layer and a normalization layer.

3. The method Method-according to claim 2, further comprising choosing the ratio between the size of convolution layer of the encoder block and the normalization layer of the encoder block.

4. The method according to claim 1, wherein the decoder block includes an unsampling convolution layer, a rectified linear unit layer and a normalization layer.

5. An automotive lighting arrangement, the automotive lighting arrangement comprising:
an automotive control unit including an encoder block configured to process image data; and
a lighting module including a decoder block configured to receive processed image data to restore the original version of the image data, wherein the lighting module is also configured to project a light pattern based on the image data restored by the decoder block;
wherein the encoder block and the decoder block have undergone a common training process being part of the same deep autoencoder.

6. The automotive lighting device according to claim 5, wherein the lighting module includes solid-state light sources.

7. A method for operating an automotive lighting arrangement, comprising:
operating the encoder block to reduce the data size of some image data, producing processed image data;
transmitting the processed image data to the decoder block;
operating the decoder block to process the processed image data to produce a restored image data; and
operating the lighting module to project a light pattern based on the restored image data.

8. The method according to claim 7, further comprising normalizing the image data before operating the encoder block to reduce its data size.

9. The method according to claim 8, wherein normalizing the image data includes converting each value of the image data in a converted value between 0 and 1.

10. The method according to claim 7, further comprising dividing the image data in data subarrays of the same format.
